(19) United States
(12) Patent Application Publication
(10) Pub. No.: US 2025/0066957 A1
(43) Pub. Date: Feb. 27, 2025

(54) FLAME RESISTANT NYLON NANOFIBERS USING POLYPHENOLS

(71) Applicant: The Government of the United States of America, as represented by the Secretary of the Navy, Arlington, VA (US)

(72) Inventors: Jeffrey G. Lundin, Burke, VA (US); Meghanne Tighe, Falls Church, VA (US); Matthew D. Thum, Annapolis, MD (US); Nickolaus Weise, Alexandria, VA (US)

(73) Assignee: The Government of the United States of America, as represented by the Secretary of the Navy, Arlington, VA (US)

(21) Appl. No.: 18/809,486

(22) Filed: Aug. 20, 2024

Related U.S. Application Data
(60) Provisional application No. 63/578,010, filed on Aug. 22, 2023.

(51) Int. Cl. D01F 6/60; C08G 69/08; C08G 69/26; C08K 5/134; D01D 5/00; D01F 1/07; D04H 1/4334; D04H 1/4382; D04H 1/728

(52) U.S. Cl. CPC D01F 6/60; C08G 69/08; C08G 69/26; C08K 5/1345; D01D 5/0038; D01F 1/07; D04H 1/4334; D04H 1/43838; D04H 1/728; D10B 2331/02; D10B 2401/04

(57) ABSTRACT

Disclosed herein is a composition having a nylon polymer and tannic acid. The nylon polymer and the tannic acid are homogenously distributed in the composition. The composition may be made by dissolving a nylon polymer and tannic acid in a solvent to form a solution and removing the solvent from the solution to form the composition.

### REFERENCE TO RELATED APPLICATIONS

This application claims the benefit of U.S. Provisional Application No. 63/578,010, filed on Aug. 22, 2023. The provisional application and all other publications and patent documents referred to throughout this nonprovisional application are incorporated herein by reference.

### TECHNICAL FIELD

The present disclosure is generally related to flame resistant nylon.

### DESCRIPTION OF THE RELATED ART

Incorporating flame-retardant compounds into polymeric composites has uses in many applications such as textiles, furniture, electronics, and as of recent interest, membrane separators for lithium-ion batteries.¹⁻⁵ There are traditionally two methods used for adding flame retardants to polymers: through direct addition to the polymer matrix and by a subsequent surface coating to the polymer. Typically, flame retardants are added to polymers as a surface coating by spraying, brushing, or submerging in a solution.⁶ This can be beneficial as it does not typically change the structural integrity of the polymer material underneath, however, it can also be problematic as the surface coating can degrade and lose its adhesion to the material over time with heat exposure and general weathering. Alternatively, flame-retardant compounds that can be incorporated directly into the polymer matrix may provide more uniform and robust flame-retardant properties. However, at high concentrations this can also affect the structural integrity of the polymeric material making it difficult to achieve both stability and adequate flame retardancy.

Currently, halogenated flame retardants are the most widely used, however they are under scrutiny due to justified health and environmental concerns.^{7, 8} Therefore, there is increasing interest in pursuing eco-friendly flame-retardant alternatives. Poly-phenols have shown significant promise as a family of non-toxic biomolecules used as naturally occurring flame-retardant materials.^{1, 9, 10} Poly-phenols are excellent char-formers and good radical scavengers making them ideal flame-retardant materials; however, they rapidly degrade at high temperatures making it challenging to fabricate polymer composites.⁹ Tannic acid (TA) is a naturally occurring poly-phenol that has a high char-forming tendency due to its network of aromatic rings and is an exceptional radical-scavenger.¹¹ Upon heating to the point of thermal decomposition (ca. 200-230° C.), TA acts as an intumescent material, releasing CO₂, and the pyrolysis of the aromatic rings leads to the formation of a char layer thus insulating the underlying material.

Previous studies have treated textiles, such as cotton and silk, with tannic acid and found it imbued good flame-retardant properties.¹²⁻¹⁵ However, each of these studies coated the textile surface through submersion in a TA solution, which can provide a challenge where the TA coating can run the risk of removal through washing or weathering. Previous studies have shown that approximately 30-40% tannic acid by weight is necessary for self-extinguishment, which provides a challenge, as high TA concentrations can negatively impact a polymer's physical properties.¹⁶

Electrospun flame-retardant materials have been used extensively for filtration applications and are emerging as separators for lithium ion batteries.^{2, 5, 17-22} Additionally, recent studies using electrospinning to incorporate tannic acid into a polymeric material have found it to be antibacterial.^{23, 24}

The most common electrospinning process uses high voltage applied to the end of a needle tip, through which a polymer solution is passed using a syringe pump, to accelerate the newly formed polymer jet towards a grounded collector plate. During this process, rapid solvent evaporation results in the formation of polymeric fibers, which are then collected on the grounded plate. As a processing technique, electrospinning is a facile and versatile method of preparing nanofibrous materials from a library of different polymer scaffolds and additives ranging in scale from nm to microns. Fibers can be prepared with varying morphologies, including core-sheath, multi-core sheath, beaded, hollow, porous, webbed, and more.^{21, 25-29}

Nylon is a commonly used polymer for the development of flame-retardant materials. It has been used extensively in composites,³⁰ fibers,³¹ and is a common polymer for electrospinning applications and uniform nanofibers can be produced in the presence of high concentrations of additive.^{32, 33} Despite its extensive use in many facets of industry and research, nylon is a flammable polymer. Its most used compositions, nylon 6 and nylon 6,6 are considered combustible in open air, have a V-2 flame-retardant grade in the UL 94 method and limited oxygen index of ca. 24%.^{34, 35} Additionally, both nylon 6 and nylon 6,6 have high heat release, rapid flame propagation, flaming solution dripping, and toxic gas release upon combustion. In particular, the flammable dripping is of primary concern due to the flaming droplets contributing to flame propagation.^{36, 37} Electrospun flame-retardant nylon fibers have been made using phosphorous-containing,¹⁸ magnesium oxide (MgO),³⁸ and mineral clays,³⁹ but have not thus far examined the use of the bio-based polyphenol flame-retardant materials such as TA that have been used in composites.

### SUMMARY OF THE INVENTION

Disclosed herein is a composition comprising: a nylon polymer and tannic acid. The nylon polymer and the tannic acid are homogenously distributed in the composition.

Also disclosed herein is a method comprising: dissolving a nylon polymer and tannic acid in a solvent to form a solution and removing the solvent from the solution to form a composition. The nylon polymer and the tannic acid are homogenously distributed in the composition.

### BRIEF DESCRIPTION OF DRAWINGS

A more complete appreciation will be readily obtained by reference to the following Description of the Example Embodiments and the accompanying drawings.

FIGS. 1A-B show images of nanofibrous mats containing 10 (FIG. 1A) and 100 (FIG. 1B) rel. wt % tannic acid (TA).

FIG. 2A-F show a general increase in fiber morphology with the addition of tannic acid as shown by SEM images of fibers made with 0 (FIG. 2A), 50 (FIG. 2B) and 100 (FIG. 2C) rel. wt % TA (Scale bar=1 μm). Fiber morphology and uniform incorporation of TA was further verified by optical microscopy of a fibrous mat made with 100 rel. wt % TA as shown at three different magnifications (FIGS. 2D-F).

FIG. 3 shows ATRFTIR of electrospun nanofibers. The characteristic regions are highlighted in grey. Nylon/TA composites are shown at 10 rel. wt % and 100 rel. wt %.

FIG. 4A shows TGA ramps of nylon nanofibers with 0 (highest curve at 350° C.), 10, 30, 50, 75, and 100 (lowest curve at 350° C.) rel. wt % TA under N₂. FIG. 4B shows TGA ramps of nylon nanofibers with 10 (upper curve) and 100 (lower curve) rel. wt % TA heated from ambient to 50° C. under N₂ before switching the atmosphere to air.

FIGS. 5A-F show exposure of nanofibrous mats to an open flame. The mats were directly exposed for ca. 2 seconds before the ignition source was removed. Results are shown for mats without TA (FIGS. 5A-C) and with 100 rel. wt % TA (FIGS. 5D-F). FIGS. 5A, D: Before ignition. FIGS. 5B, E: During flame exposure. FIGS. 5C, F: Images taken 10 seconds after exposure.

FIG. 6 shows the structure of tannic acid.

### DETAILED DESCRIPTION

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein is the incorporation of high concentrations (e.g. ≤50 wt %) of a naturally-occurring flame retardant, tannic acid, into a nylon polymer matrix using electrospinning without detrimental effects to fiber morphology. The resulting non-woven fibrous can be prepared in a facile manner and the resultant non-woven mats act as flame retardant materials. Neat nylon is a flammable polymer, but with the nylon/tannic acid mats are high char-forming, self-extinguishing, and eliminate flaming melt dripping that is common for neat nylon. The mats prepared are flexible and high surface area suggesting possible applications such as filtration, textiles, and polymer coatings.

A composition may be made using a nylon polymer and tannic acid. Both are dissolved in a solvent to form a solution. The two solids may be dissolved simultaneously or sequentially in either order. Example nylon polymers include, but are not limited to, nylon 6 and nylon 6,6. One suitable solvent is aqueous formic acid. The amount of tannic acid relative to the nylon polymer may be, for example, from 10 wt % to 100 wt %, including 50 wt %.

The solvent is removed from the solution in a manner that leave the nylon polymer and the tannic acid homogenously distributed in a composition. Some amount of solvent, such a trace amount, may remain in the composition if the composition is solid. One example way to remove the solvent is electrospinning as described herein and elsewhere in the art. Electrospinning will produce a fiber or nanofiber comprising the composition. The fibers may be formed into a nanofibrous mat as part of the electrospinning process.

The tannic acid (flame retardant) loading can achieves 50 wt % with the potential of increasing the mass percentage. Using electrospinning as an ambient temperature processing technique enables the production of flexible, fibrous mats that compensate for some of the detrimental effects of high concentrations of tannic acid on the mechanical properties of polymer composites. Traditional polymer processing techniques, such as melt-processing, are not capable of incorporation such high concentrations of tannic acid due to its relatively low thermal decomposition temperature.

Electrospinning was used to formulate and evaluate the efficacy of TA as a flame-retardant additive in nylon fiber compositions. Importantly, electrospinning enabled the very high loading (up to 1:1 ratio) of TA in nylon while maintaining fiber morphology. TA was shown to be an effective fire-retardant additive for nylon fibers by suppressing combustion, flammable oil drip and promoting self-extinguishment. At TA loading levels greater than 75 rel. wt %, heat release values exceeding the required minima for acceptable flame-retardant levels were attained which was further substantiated by open flame tests, where the TA-nylon fibers resisted burning with exposure to open flame. The mechanism of flame retardancy imparted by TA into nylon appeared to be intumescent char formation from the TA components. Importantly, the electrospinning enables the incorporation of TA at the necessary levels to impart flame retardancy, which has been a challenge for previous polymer/TA composites. The nanofibrous morphology and flexible mat achieved using electrospinning also helps compensate for the loss of mechanical properties and increase in rigidity observed with using TA as a flame retardant. The nonwoven TA/nylon mats have potential to serve as standalone flame-retardant materials in various applications, and importantly serves as a prototype showing the feasibility of using TA in nylon fibers for applications such as filtration and membranes that require both high flame resistance and a microporous structure.

The following examples are given to illustrate specific applications. These specific examples are not intended to limit the scope of the disclosure in this application.

Materials—Nylon 6/6 (nylon) was obtained from Aldrich (429171-1 KG). Tannic acid (TA) and formic acid (88%) were purchased from Fisher Scientific. All materials were used as received without further purification.

Solution Preparation—Nanofibers were prepared by electrospinning solutions of nylon in formic acid with 0-100 wt % TA with respect to nylon (rel. wt %) (Table 1). Samples were prepared by dissolving 1.25 grams of nylon into a 10 g solution to achieve a nylon concentration of 12.5 wt %. To this 0-1.25 g of TA was added to achieve final concentrations of 0, 10, 30, 50, 75 and 100 rel. wt % TA. The solutions were sealed and heated at 60° C. overnight to dissolve the contents. After overnight heating, nylon and TA completely dissolved at all concentrations prepared. Solutions were thoroughly mixed by vortexing before electrospinning and stored for up to one week at 2-4° C.

TABLE 1
Electrospinning Solution Preparation

| | | [TA] in solution | [TA] in fibers |
|---|---|---|---|
| Nylon (g) | TA (g) | (rel. wt %^{a}) | (theoretical wt %^{b}) |
| 1.25 | 0 | 0 | 0 |
| 1.25 | 0.125 | 10.0 | 9.0 |
| 1.25 | 0.375 | 30.0 | 23.1 |
| 1.25 | 0.625 | 50.0 | 33.3 |
| 1.25 | 0.937 | 75.0 | 42.8 |
| 1.25 | 1.25 | 100 | 50.0 |

^{a}With respect to nylon.
^{b}Assuming all initial TA can be found in fibers after electrospinning.

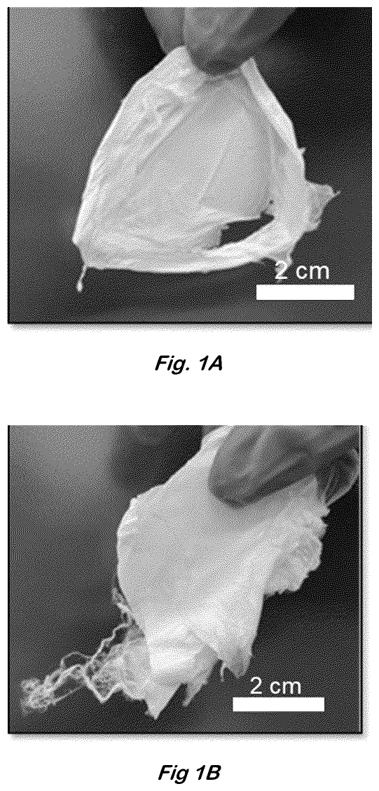

Electrospinning—Monofilament electrospinning was performed on a custom-built system using a New Era Pump Systems syringe pump (NE-300) oriented horizontally towards a grounded collector. The electrospinning solution was loaded into a 10 mL syringe with a 22 gauge needle. Fibers were electrospun at 0.9 mL·hr⁻¹, 20-22° C., and a relative humidity of <35%. The needle was set at distance of 15 cm away from the collector horizontally and the voltage between the needle and collector was set to 15 kV for samples containing 0-50 rel. wt % TA and 19-20 kV for samples with >50 rel. wt % TA. Voltage was supplied by a Bertan Series 205B high voltage power supply. Fibers were collected on aluminum foil for 4-8 hours. Non-woven mats were collected for 4-8 hours resulting in solid nanofibrous mats at all concentrations of TA tested. An example of a fibrous mat made from a solution containing 100 rel. wt % TA is given in FIG. 1. Electrospinning produced flexible mats of polymer regardless of the concentration of TA used.

Thermal Analysis—Analysis of release kinetics and fiber composition was characterized by thermogravimetric analysis (TGA) on a TA Instruments Discovery TGA using platinum pans (100 μL). Heating ramps were performed at a heating rate of 10° C.·min⁻¹ to 600° C. For analysis in air, the flow gas was switched from N₂ to air at 50° C. The char yield was measured as the percent of residual mass remaining at 600° C. Differential scanning calorimetry (DSC) was performed on a DSC Q100 V9 using a heat cool heat cycle from −60° C. to 200° C. The sample was cooled from room temperature to 20° C. at a rate of 10° C.·min⁻¹ before heating to 200° C. for the first ramp. The glass transition temperature (T_{g}) was measured on the second heating ramp using the Trios analysis tool.

Scanning Electron Microscopy (SEM)—SEM was performed on a JEOL JSM-7600F field emission scanning electron microscope (Peabody, MA) operated at an accelerating voltage of 5 kV. Samples were sputter-coated with 3 nm gold prior to SEM analysis using a Cressington 108 autosputter coater equipped with an MTM20 thickness controller. ImageJ software was utilized to measure fiber sizes from the SEM images (n≥100).

Optical Microscopy—Optical microscopy was performed using a Zeiss Axio Imager 2. Images were taken using EC Epiplan-Neofluar 5-100× objectives and processed using Zen Core software (Zeiss, Oberkochen, Germany). Fibers were collected on glass slides and were analyzed in reflection or transmission mode.

Fourier Transform Infrared Spectroscopy—Structural characterization of electrospun nanofibers was investigated through attenuated total reflectance Fourier transform infrared (ATRFTIR). Spectra were collected using a Thermo Scientific Nicolet iS50-FTIR spectrometer equipped with an iS50 ATR attachment and Ge crystal. Background and sample spectra consisted of 128 scans averaged together with 4 cm⁻¹ resolution at a scanner velocity of 10 KHz.

Flame Tests—Nanofibrous mats of ca. 100-200 mg were manually compressed into a ball ca. 1 cm in diameter and exposed to open flame from a common kitchen match. The flame was placed directly in contact with the sample from underneath for 2 seconds before being removed. The samples were analyzed for combustion, melt-dripping, and self-extinguishment within 10 seconds. Experiments were run in duplicate.

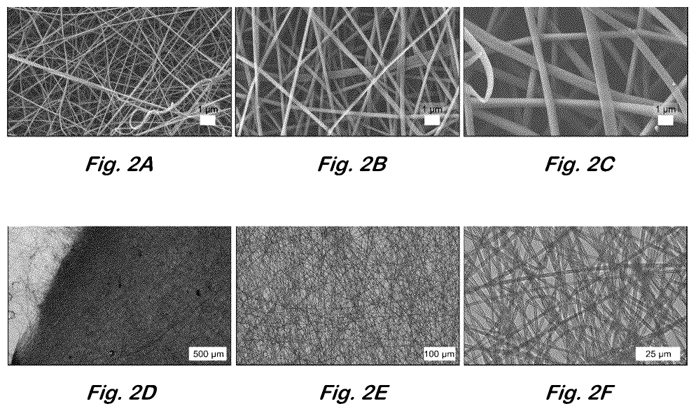

Nonwoven nylon/TA mats were prepared by electrospinning solution containing 12.5% nylon and 0-100 rel. wt % TA. Fibrous mats were analyzed using SEM and optical microscopy (FIGS. 2A-F) and compared to neat nylon nanofibers. Uniform, defect-free fibers were obtained regardless of TA loading. In the absence of TA, electrospinning resulted in a non-woven mat of ca. 100 nm fibers and the only noticeable effect of increasing TA concentration is a gradual increase in fiber diameter (Table 2). With up to 30 rel. wt % TA, there is little effect on fiber diameter as all fibers measure ca. 120 nm. At >50 rel. wt % TA there is a modest increase in fiber diameter to 258±93 nm at 50 rel. wt % and 439±86 nm at 75 rel. wt % and a diameter of 656±113 nm at 1:1 nylon/TA. Despite the increase in fiber diameter caused by increasing amounts of TA, all fibers remain cylindrical with few defects. Previous studies have shown that nylon fibers can collapse into ribbons at high (ca. >500 nm) fiber diameters due to the rapid solvent loss during electrospinning and subsequent collapse of thin fiber walls, however significant ribbons were not observed here, suggesting that TA provides some structure to the polymer network during the electrospinning process.^{26, 32}

Optical microscopy images of nylon fibers containing 100 rel. wt % TA are given in FIGS. 2D-F at three different scales. The uniformity of the non-woven mat can be seen in the microscopy images. The edge of the mat illustrating the non-woven and highly porous nature of the materials is given in FIG. 2D. The mat is comprised of a uniform distribution of nanofibers, even at high (1:1) TA loadings. As shown in images at higher magnification (FIGS. 2E, F), there are no visible defects in the fiber morphology. Neat nylon is an optically clear material and, surprisingly, the fibers are still relatively clear at 100 rel. wt % TA loadings. The uniformity of the fibers suggest that the TA is evenly distributed within the polymer matrix. If the components were incompatible with one another, one would expect some phase separation during electrospinning leading to beaded or otherwise non-uniform fibers. However, the high solubility of both TA and nylon in the electrospinning solution suggests that the two materials are highly compatible with one another resulting in remarkably uniform cylindrical fiber morphologies, even at extremely high TA loadings.

TABLE 2
Electrospun Fiber Diameters

| [TA] (rel. wt %) | Diameter (nm)^{a} |
|---|---|
| Neat | 119 ± 34 |
| 10 | 115.0 ± 15 |
| 30 | 130 ± 15 |
| 50 | 258 ± 93 |
| 75 | 439 ± 86 |
| 100 | 656 ± 113 |

^{a}Determined using Image J based on SEM images with n ≥ 100

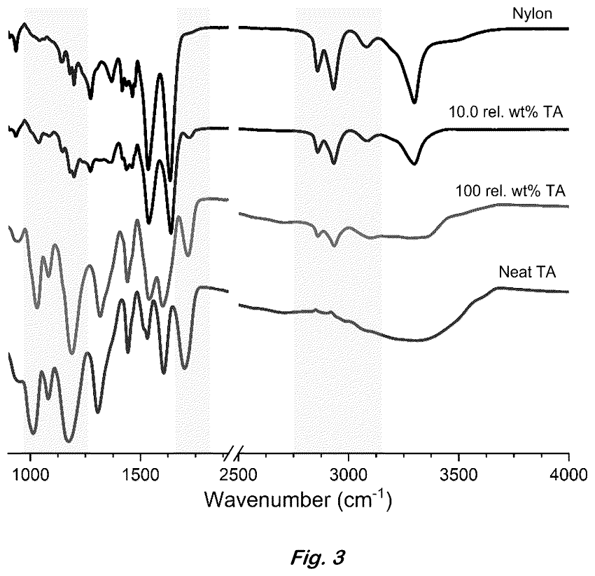

The structural composition of Nylon/TA fibers was investigated using ATRFTIR. Neat TA (FIG. 3, bottom curve) has characteristic absorbance peaks at 1004 cm⁻¹, 1161 cm⁻¹, a CH₂ aromatic stretch at 1598 cm⁻¹, a carbonyl stretch at 1694 cm⁻¹ (vₛ(C═O)), and a broad OH stretch at ca. 3300 cm⁻¹ corresponding to the phenols. Neat nylon (FIG. 3, top curve) exhibits a characteristic sharp N—H stretch centered at 3300 cm⁻¹, peak corresponding to CH₂ stretches at 2933 (vₛ(CH₂) asymmetric) and 2860 cm⁻¹ (vₛ(CH₂) symmetric), and amide stretches at 1636 cm⁻¹ (amide I, vₛ(CO), 1536 cm⁻¹ (amide II, vₛ(NH), and 1275 cm⁻¹ (amide III). Spectra of Nylon/TA composite fibers indicate even distribution of TA within the polymer matrix. Spectra of nanofibers containing 10 and 100 rel. wt % TA are given in FIG. 3. With increasing concentration of TA, there is a corresponding increase in the characteristic TA peaks discussed above. At 100 rel. wt %, peaks corresponding to TA and nylon are visible in relatively equal intensity. The CH₂ stretches for nylon at ca. 2900 cm⁻¹ and the OH stretch for TA at ca. 3300 cm⁻¹ are unshifted in the composite relative to neat starting materials, however, the nylon amide stretches are compressed, and the TA carbonyl stretch shifts to 1708 cm⁻¹ in the composite fibers. Shifts in the amide and carbonyl regions indicate interactions between the polar amide regions of nylon and the aromatic esters on TA further suggesting that TA is interspersed within the nylon matrix and does not exist in phase-separated regions.

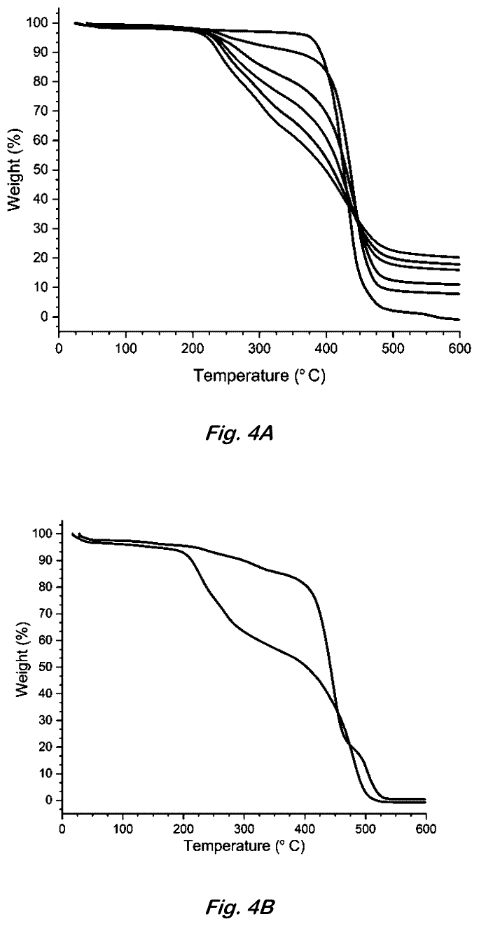

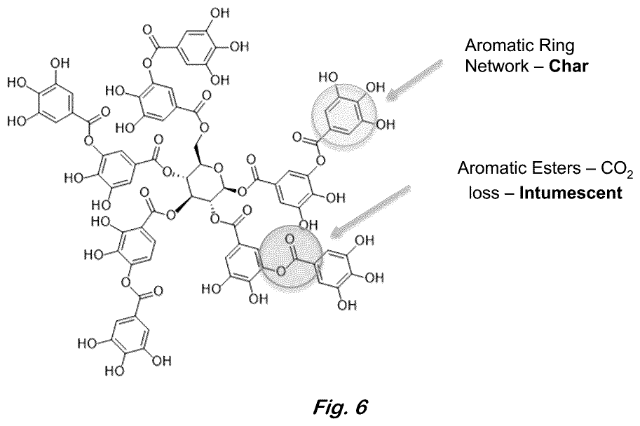

Thermal analysis of nanofibrous mats was performed in N₂ and air using TGA from ambient to 600° C. (FIGS. 4A-B). A summary of the thermal properties is provided in Table 3. Under nitrogen, there is a single weight loss for neat nylon at 422° C. corresponding to its thermal decomposition and composite fibers show an additional weight loss peak at ca. 250° C. corresponding to the decomposition of TA. When compared with neat nylon, incorporation of TA does not negatively affect its peak thermal decomposition temperature. Indeed, at 100 rel. wt % TA, nylon decomposes at 421° C. indicating that the incorporation of high concentrations of TA have little effect on the stability of the polymer matrix. The residual mass at 375° C. gives an indication of the TA loading in the electrospun fibers as the nylon has not yet degraded and indicated that much of the TA loaded into the electrospinning solution is incorporated into the polymer fibers. Finally, the residual mass at 600° C. gives an estimation of the char-forming ability of the material. With increasing TA loadings, there is an increase in the residual mass. There is no residual mass for neat nylon, but at only 10 rel. wt % there is an increase to 7.8% mass remaining. The residual mass continues to increase with TA loadings resulting in a maximum of 20.2% remaining for 100 rel. wt % TA. The residual mass is an indication that the TA is still able to char and act as an intumescent material (FIG. 6) when dispersed within the polymer network. Additionally, a char yield of ≥20% indicates good fire resistance.

TABLE 3
Thermal Properties of Electrospun Fibers

| | | | | Residual | Residual |
|---|---|---|---|---|---|
| [TA] | T_{onset 10%} | Tₘₐₓ₁ | Tₘₐₓ₂ | Mass at | Mass at |
| (rel. wt %) | (° C.)^{a} | (° C.)^{b} | (° C.)^{c} | 375° C. (%)^{d} | 600° C. (%)^{e} |
| Neat | 390 | 422 | — | 95.3 | 0.0 |
| 10 | 354 | 247 | 438 | 88.4 | 7.84 |
| 30 | 273 | 272 | 439 | 76.0 | 11.0 |
| 50 | 252 | 255 | 432 | 68.2 | 15.9 |
| 75 | 248 | 247 | 430 | 61.2 | 17.9 |
| 100 | 238 | 238 | 421 | 56.3 | 20.2 |

^{a}Recorded as the residual mass after heating to 600° C. under N₂ as measured by TGA.
^{b}Temperature at first maximum weight loss rate.
^{c}Temperature at second maximum weight loss rate.
^{a-e}Under N₂.

Thermal analysis was also performed in air for 10 and 100 rel. wt % TA fibers. In air, there is little effect on the thermal decomposition of nylon, or TA, but there was no residual mass at 600° C. The lack of residual mass under air is expected due to thermal oxidation reactions. Importantly, however, the TGA curves in air and nitrogen are otherwise near-superimposable indicating that the presence of oxygen does not affect the properties of nylon/TA composite fibers.

The polymer properties of Nylon/TA fiber were further investigated using DSC. The melting transition temperature of the nylon used in this study was near the decomposition temperature of TA so the samples were analyzed from −60° C.-200° C. to avoid thermal decomposition enabling the sample to be cycled multiple times. Nylon is a crystalline polymer and neat nylon fibers fabricated in this work have a weak glass transition temperature (T_{g}) at 80.7° C. With the addition of 10 rel. wt % TA, the T_{g} increases to 92.3° C. suggesting that TA interacts strongly with nylon and decreases chain flexibility and is consistent with the compression of the amide stretches seen in the IR spectra. Interestingly, increasing the TA concentration increases the T_{g} to a maximum of 96.5° C. at 50 rel. wt % TA, but the T_{g} begins to decrease again at 75 and 100 rel. wt % TA to ca. 92° C. The T_{g} of all TA samples is higher than for neat nylon indicating that nylon/TA composites become more rigid, but the decrease in T_{g} at high TA loading is most likely due to chain separation in concentrated TA composites. The glass transition temperatures of electrospun nanofibers are summarized in Table 4.

TABLE 4
T_{g} of Nylon/TA Fibers

| [TA] (rel. wt %) | T_{g} (° C.)^{a} |
|---|---|
| Neat | 80.7 |
| 10 | 92.3 |
| 30 | 95.2 |
| 50 | 96.5 |
| 75 | 91.9 |
| 100 | 92.1 |

^{a}T_{g} measured on the second heating ramp of a heat cool heat cycle. Analyzed using Trios software.

The heat release properties of nylon/TA composite fibers were further analyzed by microscale combustion calorimetry (MCC). The heat release capacity decreased significantly with the addition of TA. At 10 rel. wt %, the heat release capacity decreased by 32% from 626 to 424 J·g⁻¹·K⁻¹ respectively when compared with neat nylon. The heat release capacity continues to decrease with increasing TA until at ≥75 rel. wt % TA it drops below the minimum value of 200 J·g⁻¹·K⁻¹ to be considered flame resistant with an ultimate reduction in heat capacity of 74% for 100 rel. wt % TA. Likewise, the total heat release (THR) decreases significantly with increasing TA. The decrease starts to become significant at 30 rel. wt % TA loading with a decrease of 22% in THR and becomes more prominent for 75 and 100 rel. wt % TA with a decrease of 42 and 46% respectively. These results further demonstrate the impact on the flame resistance of nylon, turning what started as a flammable polymer into a flame-retardant composite. These data are comparable to some of the most recent TA-based flame-retardant materials and coatings and demonstrate the feasibility of this technique for preparing flame-retardant nylon composites.⁴⁰

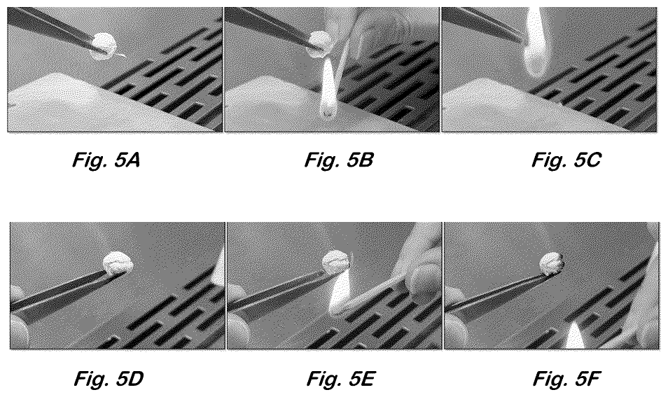

Compressed fibrous mats weighing 100-200 mg and measuring ca. 1 cm in diameter were exposed to an open flame to investigate their performance. A summary of open flame tests for fibrous mats is given in Table 5. As previously mentioned, nylon will melt, drip, and generally shrink away from the ignition source without charring. This can be seen in FIGS. 5A-C, which show the exposure of a nanofibrous nylon mat to an open flame source. Seconds after exposure, the mat ignites and burns rapidly. During combustion, there are flaming drops of melted polymer that fall from the burning sample until there is no remaining residue (FIG. 5C). At ≥30 rel. wt % TA The flaming drip ceases completely, and the materials self-extinguish within ten seconds. The fibrous mat with 75 rel. wt % TA still catches on fire, but immediately chars and is almost immediately extinguished. The significant charring of the exposed area leaves the unexposed area essentially unaffected. Finally, at 100 rel. wt %, the polymer does not combust and is only minimally affected by open flame exposure (FIGS. 5D-F). The charred area remains small and completely insulates the unexposed areas of the fibrous mat. Any ignition is immediately extinguished without afterglow and no melt-dripping. Repeatedly exposing the mat to flame does not result in combustion, rather the degradation of TA leads to significant bubbling and charring and the propagation of charred areas until the entire mat has degraded.

TABLE 5
Flame Resistance of Nanofibrous Mats

| | Heat Release | | | | |
|---|---|---|---|---|---|
| [TA] | Capacity^{a} | THR^{a} | Com- | | Self-Extin- |
| (rel. wt %) | (J · g⁻¹ · K⁻¹) | (kJ · g⁻¹) | bustion^{b} | Drip^{b} | guishment^{b,c} |
| 0.0 | 626 ± 63.5 | 27.6 ± 1.7 | YES | YES | NO |
| 10 | 424 ± 59.7 | 26.0 ± 4.2 | YES | YES | NO |
| 30 | 317 ± 8.5 | 21.5 ± 1.0 | YES | NO | YES |
| 50 | 248 ± 7.0 | 18.2 ± 1.0 | YES | NO | YES |
| 75 | 197 ± 21.6 | 16.0 ± 0.9 | YES | NO | YES |
| 100 | 165 ± 14.5 | 12.7 ± 1.4 | NO | NO | YES |

^{a}Average of three measurements.
^{b}n = 2.
^{c}within 10 seconds of ignition.

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

### REFERENCES

1. Kulkarni, S.; Xia, Z. Y.; Yu, S. R.; Kiratitanavit, W.; Morgan, A. B.; Kumar, J.; Mosurkal, R.; Nagarajan, R., Bio-Based Flame-Retardant Coatings Based on the Synergistic Combination of Tannic Acid and Phytic Acid for Nylon-Cotton Blends. Acs Appl Mater Inter 2021, 13 (51), 61620-61628.
2. Lei, T. Y.; Chen, W.; Hu, Y.; Lv, W. Q.; Lv, X. X.; Yan, Y. C.; Huang, J. W.; Jiao, Y.; Chu, J. W.; Yan, C. Y.; Wu, C. Y.; Li, Q.; He, W. D.; Xiong, J., A Nonflammable and Thermotolerant Separator Suppresses Polysulfide Dissolution for Safe and Long-Cycle Lithium-Sulfur Batteries. Adv Energy Mater 2018, 8 (32).
3. Selvakumar, N.; Azhagurajan, A.; Natarajan, T. S.; Khadir, M. M. A., Flame-retardant fabric systems based on electrospun polyamide/boric acid nanocomposite fibers. Journal of Applied Polymer Science 2012, 126 (2), 614-619.
4. Vahabi, H.; Wu, H.; Saeb, M. R.; Koo, J. H.; Ramakrishna, S., Electrospinning for developing flame retardant polymer materials: Current status and future perspectives. Polymer 2021, 217.
5. Zhou, Z. F.; Chen, B. B.; Fang, T. T.; Li, Y.; Zhou, Z. F.; Wang, Q. J.; Zhang, J. J.; Zhao, Y. F., A Multifunctional Separator Enables Safe and Durable Lithium/Magnesium-Sulfur Batteries under Elevated Temperature. Adv Energy Mater 2020, 10 (5).
6. Liang, S. Y.; Neisius, N. M.; Gaan, S., Recent developments in flame retardant polymeric coatings. Prog Org Coat 2013, 76 (11), 1642-1665.
7. Alaee, M.; Arias, P.; Sjodin, A.; Bergman, A., An overview of commercially used brominated flame retardants, their applications, their use patterns in different countries/regions and possible modes of release. Environ Int 2003, 29 (6), 683-689.
8. Betts, K. S., New thinking on flame retardants. Environ Health Persp 2008, 116 (5), A210-A213.
9. Xia, Z. Y.; Kiratitanavit, W.; Facendola, P.; Yu, S. R.; Kumar, J.; Mosurkal, R.; Nagarajan, R., A Bio-derived Char Forming Flame Retardant Additive for Nylon 6 Based on Crosslinked Tannic Acid. Thermochim Acta 2020, 693.
10. Xia, Z. Y.; Singh, A.; Kiratitanavit, W.; Mosurkal, R.; Kumar, J.; Nagarajan, R., Unraveling the mechanism of thermal and thermo-oxidative degradation of tannic acid. Thermochim Acta 2015, 605, 77-85.
11. Hagerman, A. E.; Riedl, K. M.; Jones, G. A.; Sovik, K. N.; Ritchard, N. T.; Hartzfeld, P. W.; Riechel, T. L., High molecular weight plant polyphenolics (tannins) as biological antioxidants. J Agr Food Chem 1998, 46 (5), 1887-1892.
12. Nam, S.; Condon, B. D.; Xia, Z. Y.; Nagarajan, R.; Hinchliffe, D. J.; Madison, C. A., Intumescent flame-retardant cotton produced by tannic acid and sodium hydroxide. J Anal Appl Pyrol 2017, 126, 239-246.
13. Wang, Z. H.; Zhang, A. N.; Liu, B. W.; Wang, X. L.; Zhao, H. B.; Wang, Y. Z., Durable flame-retardant cotton fabrics with tannic acid complexed by various metal ions. Polym Degrad Stabil 2022, 201.
14. Zhang, A. N.; Liu, B. W.; Zhao, H. B.; Wang, Y. Z., Eco-friendly and durable flame-retardant coating for cotton fabrics based on dynamic coordination of Ca2+-tannin acid. Prog Org Coat 2022, 170.
15. Zhang, W.; Yang, Z. Y.; Tang, R. C.; Guan, J. P.; Qiao, Y. F., Application of tannic acid and ferrous ion complex as eco-friendly flame retardant and antibacterial agents for silk. J Clean Prod 2020, 250.
16. Basak, S.; Raja, A. S. M.; Saxena, S.; Patil, P. G., Tannin based polyphenolic bio-macromolecules: Creating a new era towards sustainable flame retardancy of polymers. Polym Degrad Stabil 2021, 189.
17. Zhu, Y.; Han, X.; Xu, Y.; Liu, Y.; Zheng, S.; Xu, K.; Hu, L.; Wang, C., Electrospun Sb/C fibers for a stable and fast sodium-ion battery anode. ACS Nano 2013, 7 (7), 6378-86.
18. Liu, K.; Liu, C.; Hsu, P. C.; Xu, J.; Kong, B.; Wu, T.; Zhang, R.; Zhou, G.; Huang, W.; Sun, J.; Cui, Y., Core-Shell Nanofibrous Materials with High Particulate Matter Removal Efficiencies and Thermally Triggered Flame Retardant Properties. ACS Cent Sci 2018, 4 (7), 894-898.
19. Pu, Y.; Yang, X.; Zhang, Y.; Li, L.; Xie, Y.; He, B.; Yuan, D.; Ning, X., Fabrication and Characterization of Highly Oriented Composite Nanofibers with Excellent Mechanical Strength and Thermal Stability. Macromolecular Materials and Engineering 2020, 305 (3).
20. Chen, Y.; Qiu, L.; Ma, X.; Dong, L.; Jin, Z.; Xia, G.; Du, P.; Xiong, J., Electrospun cellulose polymer nanofiber membrane with flame resistance properties for lithium-ion batteries. Carbohydr Polym 2020, 234, 115907.
21. Lu, T.; Cui, J.; Qu, Q.; Wang, Y.; Zhang, J.; Xiong, R.; Ma, W.; Huang, C., Multistructured Electrospun Nanofibers for Air Filtration: A Review. ACS Appl Mater Interfaces 2021, 13 (20), 23293-23313.
22. Zhang, H.; Xie, Y.; Song, Y.; Qin, X., Preparation of high-temperature resistant poly(m-phenylene isophthalamide)/polyacrylonitrile composite nanofibers membrane for air filtration. Colloids and Surfaces A: Physicochemical and Engineering Aspects 2021, 624.
23. Chen, X. F.; Zhang, Q. Q.; Wang, Y.; Meng, J.; Wu, M. Q.; Xu, H. Z.; Du, L.; Yang, X. H., Fabrication and Characterization of Electrospun Poly(Caprolactone)/Tannic Acid Scaffold as an Antibacterial Wound Dressing. Polymers 2023, 15 (3).
24. Rajamohan, R.; Raorane, C. J.; Kim, S. C.; Ramasundaram, S.; Oh, T. H.; Murugavel, K.; Lee, Y. R., Encapsulation of tannic acid in polyvinylidene fluoride mediated electrospun nanofibers and its antibiofilm and antibacterial activities. J Biomat Sci-Polym E 2023.
25. Fong, H.; Chun, I.; Reneker, D. H., Beaded nanofibers formed during electrospinning. Polymer 1999, 40 (16), 4585-4592.
26. Koombhongse, S.; Liu, W. X.; Reneker, D. H., Flat polymer ribbons and other shapes by electrospinning. J Polym Sci Pol Phys 2001, 39 (21), 2598-2606.
27. Chen, H.; Wang, N.; Di, J.; Zhao, Y.; Song, Y.; Jiang, L., Nanowire-in-microtube structured core/shell fibers via millifluidic coaxial electrospinning. Langmuir 2010, 26 (13), 11291-6.
28. Kye, Y.; Kim, C.; Lagerwall, J., Multifunctional responsive fibers produced by dual liquid crystal core electrospinning. Journal of Materials Chemistry C 2015, 3 (34), 8979-8985.
29. Xue, J.; Wu, T.; Dai, Y.; Xia, Y., Electrospinning and Electrospun Nanofibers: Methods, Materials, and Applications. Chem Rev 2019, 119 (8), 5298-5415.
30. Gao, J.; Wu, Y.; Li, J.; Peng, X.; Yin, D.; Jin, H.; Wang, S.; Wang, J.; Wang, X.; Jin, M.; Yao, Z., A review of the recent developments in flame-retardant nylon composites. Composites Part C: Open Access 2022, 9.
31. Guo, X.; Liu, L.; Feng, H.; Li, D.; Xia, Z.; Yang, R., Flame Retardancy of Nylon 6 Fibers: A Review. Polymers (Basel) 2023, 15 (9).
32. Thum, M. D.; Weise, N. K.; Casalini, R.; Fulton, A. C.; Purdy, A. P.; Lundin, J. G., Incorporation of N,N,-diethyl-meta-toluamide within electrospun nylon-6/6 nanofibers. Journal of Applied Polymer Science 2022, 139 (48).
33. Ryan, J. J.; Casalini, R.; Orlicki, J. A.; Lundin, J. G., Controlled release of the insect repellent picaridin from electrospun nylon-6,6 nanofibers. Polym Advan Technol 2020, 31 (12), 3039-3047.
34. Liu, Y.; Wang, Q., Melamine cyanurate-microencapsulated red phosphorus flame retardant unreinforced and glass fiber reinforced polyamide 66. Polym Degrad Stabil 2006, 91 (12), 3103-3109.
35. Fan, S.; Yuan, R.; Wu, D.; Wang, X.; Yu, J.; Li, F., Silicon/nitrogen synergistically reinforced flame-retardant PA6 nanocomposites with simultaneously improved anti-dripping and mechanical properties. RSC Adv 2019, 9 (14), 7620-7628.
36. Horrocks, A. R., Flame retardant challenges for textiles and fibres: New chemistry versus innovatory solutions. Polym Degrad Stabil 2011, 96 (3), 377-392.
37. Li, X. H.; Shao, L. B.; Song, N.; Shi, L. Y.; Ding, P., Enhanced thermal-conductive and anti-dripping properties of polyamide composites by 3D graphene structures at low filler content. Compos Part a-Appl S 2016, 88, 305-314.
38. Dhineshbabu, N. R.; Karunakaran, G.; Suriyaprabha, R.; Manivasakan, P.; Rajendran, V., Electrospun MgO/Nylon 6 Hybrid Nanofibers for Protective Clothing. Nano-Micro Letters 2014, 6 (1), 46-54.
39. Wu, H.; Krifa, M.; Koo, J. H., Flame retardant polyamide 6/nanoclay/intumescent nanocomposite fibers through electrospinning. Textile Research Journal 2014, 84 (10), 1106-1118.
40. Kulkarni, S.; Xia, Z.; Yu, S.; Kiratitanavit, W.; Morgan, A. B.; Kumar, J.; Mosurkal, R.; Nagarajan, R., Bio-Based Flame-Retardant Coatings Based on the Synergistic Combination of Tannic Acid and Phytic Acid for Nylon-Cotton Blends. ACS Appl Mater Interfaces 2021, 13 (51), 61620-61628.

What is claimed is:

1. A composition comprising:
a nylon polymer; and
tannic acid;
wherein the nylon polymer and the tannic acid are homogenously distributed in the composition.

2. The composition of claim 1, wherein the nylon polymer is nylon 6.

3. The composition of claim 1, wherein the nylon polymer is nylon 6,6.

4. The composition of claim 1, wherein the tannic acid has a wt % of at least 10% relative to the nylon polymer.

5. The composition of claim 1, wherein the tannic acid has a wt % of at least 50% relative to the nylon polymer.

6. The composition of claim 1, wherein the tannic acid has a wt % of at least 100% relative to the nylon polymer.

7. The composition of claim 1, wherein the composition is in the form of a nanofiber.

8. A nanofibrous mat comprising the nanofiber of claim 7.

9. A method comprising:
dissolving a nylon polymer and tannic acid in a solvent to form a solution; and
removing the solvent from the solution to form a composition;
wherein the nylon polymer and the tannic acid are homogenously distributed in the composition.

10. The method of claim 9, wherein the nylon polymer is nylon 6.

11. The method of claim 9, wherein the nylon polymer is nylon 6,6.

12. The method of claim 9, wherein the tannic acid has a wt % of at least 10% relative to the nylon polymer in the solution.

13. The method of claim 9, wherein the tannic acid has a wt % of at least 50% relative to the nylon polymer in the solution.

14. The method of claim 9, wherein the tannic acid has a wt % of at least 100% relative to the nylon polymer in the solution.

15. The method of claim 9, wherein removing the solvent is performed by electrospinning to form a nanofiber comprising the composition.

16. The method of claim 15, further comprising:
forming a nanofibrous mat from the nanofiber.
